(19) United States
(12) Patent Application Publication
(10) Pub. No.: US 2023/0001553 A1
(43) Pub. Date: Jan. 5, 2023

(54) Slide Spring Tool

(71) Applicant: Timothy A Pazdernik, Horace, ND (US)

(72) Inventor: Timothy A Pazdernik, Horace, ND (US)

(21) Appl. No.: 17/851,848

(22) Filed: Jun. 28, 2022

Related U.S. Application Data
(60) Provisional application No. 63/217,395, filed on Jul. 1, 2021.

(51) Int. Cl. B25B 27/30

(52) U.S. Cl. CPC B25B 27/302

(57) ABSTRACT

Vehicle transmissions have many complex parts including various springs with various purposes. A rebuilder using crude tools, or the installer's fingers may struggle with the installation. Further, the rebuilder could potentially be injured or cause damage if the spring is improperly released from a state of compression. Mechanical tools can simplify the installation process. But the availability and applicability of existing tools do not always fit the shape of the required installation. This application discloses a unique transmission spring compressor tool (slide spring tool), which allows a rebuilder to install transmission springs into a transmission. The slide spring tool includes two independent pieces: a body with a receiver configured to accept a plunger and a plunger assembly. The slide spring tool is adapted to compress a slide spring, receive the slide spring in the spring gap, and place the slide spring into a slide slot on an oil pump assembly.

### CROSS-REFERENCE TO RELATED APPLICATION(S)

This application claims the priority to U.S. Provisional Patent Application No. 63/217,395, filed Jul. 1, 2021, the contents of which are hereby incorporated by reference in its entirety.

### BACKGROUND

Vehicle transmissions are often rebuilt for maintenance and repair purposes. Vehicle transmissions have many complex parts including various springs with various purposes. The transmission rebuilding process may involve a rebuilder who must install one or more springs in a location on the transmission, which requires the spring to be compressed prior to installation. The shape and nature of the installation can vary widely for each spring installation. There are many different brands and types of transmissions as well as many different spring types and locations.

Compressing springs prior to installation can be challenging at times given the pressure exerted by the spring when under the compression required to be installed in the location wherein the spring must be installed. A rebuilder using crude tools, such as a screwdriver or pliers, or the installer's fingers, may struggle with the installation. Further, the rebuilder could potentially be injured or cause damage if the spring is improperly released from a state of compression. The use of mechanical tools can simplify the installation process, but the availability and applicability of existing tools does not always fit the shape and nature of the required installation. For example, a spring compressor that works on one type of spring will not work on another. Further, a tool to install a spring at one location on the transmission might not work for the same type of spring at another location.

Given the sheer number of types of springs on the market and the sheer number of installation locations, spring compressors must uniquely be designed such that they are not excessively complicated and therefore prohibitively expensive. Transmission rebuilders are further under requirements to timely and efficiently complete transmission rebuilds. Any tools used in the rebuilding process must be able to timely and efficiently be utilized.

### SUMMARY

This disclosure is directed toward a unique transmission spring compressor tool which allows for a rebuilder to install transmission springs into a transmission. Specifically, the disclosed invention's best mode is to be used for installation of an oil pump slide spring in several models of General Motors automotive transmissions. The oil pump slide spring is located in the transmission oil pump assembly. The slide spring is installed by compressing the slide spring and laterally placing the slide spring into a slide slot. Transmission rebuilders typically use a screwdriver or pliers to force the slide spring into the slide slot. This is often times dangerous as the spring can pop out unexpectedly such that it injures the rebuilder.

The disclosed invention describes a slide spring tool device which compresses the slide spring and allows the slide spring to be transferred into the slide slot. The tool comprises (1) a body with a receiver configured to accept a plunger, (2) a plunger which is configured with a spring gap such that a properly compressed slide spring will fit in the spring gap and the plunger can slide through the receiver, and (3) a plunger plate attached to the plunger configured such to allow for the slot spring to be compressed between the bottom face of the body and the plunger plate.

The disclosed invention allows for the rebuilder to place a slide spring in the slide spring tool between the plunger plate and the bottom face of the body. The rebuilder may then apply manual pressure to compress the slide spring. When the slide spring has been compressed, the slide spring may be pushed into the slide gap. The plunger may be then removed from the body with a compressed spring in the slide gap. The rebuilder may then place the plunger with the compressed slide spring positioned over the slide slot such that the rebuilder may push the slide spring out of the slide gap into the slide slot on the oil pump assembly.

### BRIEF DESCRIPTION OF THE DRAWINGS

These and other features and advantages of the present invention will become more readily appreciated as the same becomes better understood by reference to the following detailed description when considered in connection with accompanying drawings, wherein:

FIG. 1 is a 3D image of an exemplary slide spring tool;

FIG. 2 is a set of drawings showing the 2D perspective of an exemplary slide spring tool plunger and a plunger plate;

FIG. 3 is a set of drawings showing the 2D perspective of an exemplary slide spring tool body.

### DETAILED DESCRIPTION OF THE ILLUSTRATED EMBODIMENTS

### General

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

### FIGURES DETAIL

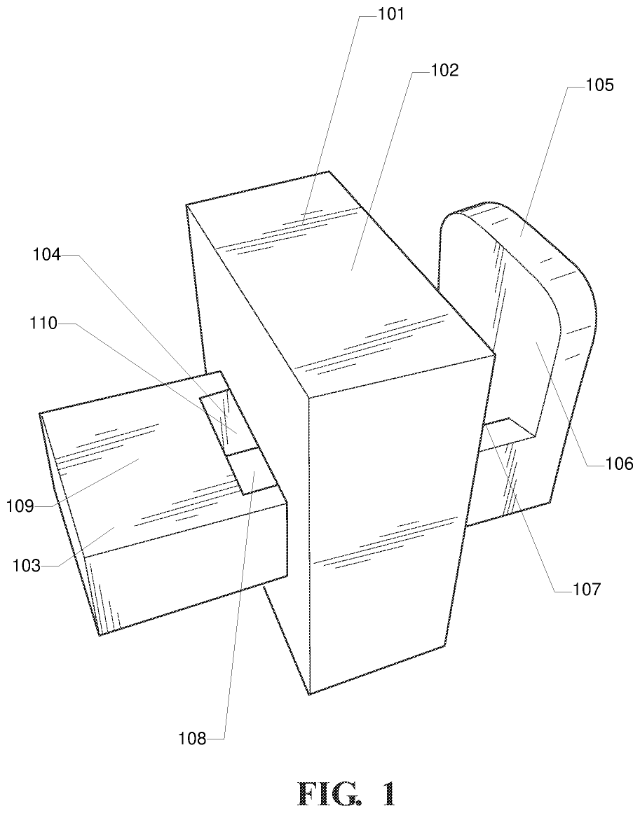

FIGS. 1 through 3 illustrate an example embodiment of a slide spring tool 101. The slide spring tool 101 comprises of two independent pieces; the body 102 and the plunger assembly 103. The slide spring tool 101 is adapted to compress a slide spring, receive the slide spring in the spring gap 104, and place the slide spring into a slide slot on an oil pump assembly. A slide spring may be for an oil pump in certain automotive transmissions.

To use the slide spring tool 101 a slide spring which is at rest and is not compressed, is placed between the plunger plate 105 and the body 102. When the slide spring is first placed, the slide spring tool 101 is in the extended position. One end of the slide spring is placed against a plunger plate face 106 located on the face of the plunger plate 105 which is facing the body 102, and the other end of the slide spring is placed against a bottom face 107 located on the face of the body 102 which is facing the plunger plate 105. The body 102 having the bottom face 107.

The plunger assembly 103 is comprised of a plunger 109 and a plunger plate 105. The plunger 109 is configured such that it can slide through a receiver 108 which is configured on the body 102. The plunger 109 is configured to be slightly smaller than the receiver 108 so that the plunger does not stick as the plunger 109 is slid through the receiver 108. The plunger assembly 103 along with the plunger 109 may be entirely removed from the receiver 108 resulting in two independent pieces. When a rebuilder uses the slide spring tool 101 to compress a slide spring, the rebuilder applies manual pressure to the plunger plate 105 such that the plunger assembly 103 is moved relative to the body 102. The plunger 109 slides in the receiver 108 and the plunger plate face 106 and the bottom face 107 of the body 102 move closer together. Once the slide spring is compressed to the desired length, the slide spring may be pushed from the location between the bottom face 107 and the plunger plate face 106 to the spring gap 104. The plunger plate 105 having a face that is a plunger plate face 106. The plunger plate face 106 located opposite to the bottom face 107 when the plunger 109 is slid in the receiver 108.

The body 102 is comprised of a receiver 108 and a block assembly 301. The receiver 108 is configured to allow the plunger 109 to slide within. The block assembly 301 is the material surrounding the receiver 108.

The block assembly 301 and plunger assembly 103 is configured of such material and shape that is capable of withstanding the force of the slide spring being compressed. Slide springs for different transmissions may require different compressive properties and, in some cases, may exert a significant amount of pressure on the slide spring tool 101. The block assembly 301 and plunger assembly 103 is configured to be of requisite size such that the rebuilder can comfortably use the slide spring tool 101. In the exemplary embodiment shown in the figures, the slide spring tool 101 is displayed in a steel or aluminum configuration which allows for rebuilder comfort as well as required structural strength.

Alternatively, the slide spring tool 101 may be crafted from materials other than steel or aluminum. Plastics with requisite structural properties may also be used for the slide spring tool 101. For example, the slide spring tool 101 may constructed from printed or blown plastic.

FIG. 1 is a 3D image of an exemplary slide spring tool 101. In the exemplary embodiment shown, the body 102 and the plunger assembly 103 are displayed in the compressed position. The figure shows an exaggerated display of the compressed position. In normal use, the plunger 109 does not need to be slid as far into the receiver 108 as shown. The figure does not show a slide spring.

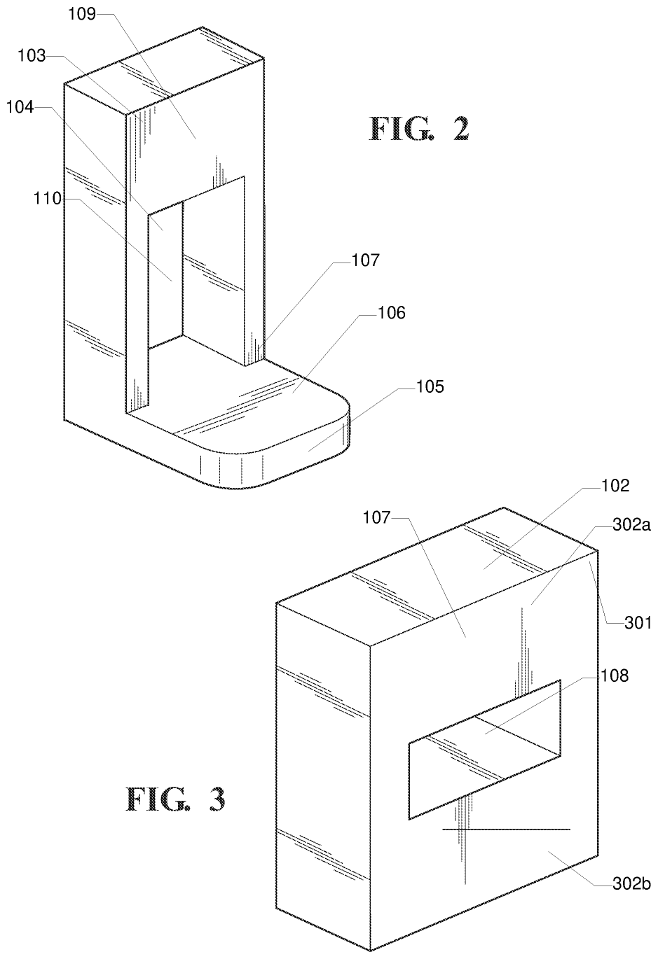

FIG. 2 is a set of drawings showing the 2D perspective of an exemplary slide spring tool 101 plunger 109 and a plunger plate 105. The drawing shows three sides of the plunger assembly 103 including the side, front, and top perspective. The plunger assembly 103 is comprised of a plunger 109 and a plunger plate 105.

The plunger 109 is comprised of a spring gap 104, and a set of plunger arms 201 (shown on the drawings as 201a and 201b). Attached to the plunger 109 is the plunger plate 105. The plunger plate face 106 is located evenly with the gap bottom 203. The gap bottom 203 and the plunger plate face 106 are located such that the slide spring may be smoothly slid on the plunger plate face 106 so that the slide spring is axially centered within the plunger 109 and the two ends of the slide spring are compressed against the gap bottom 203 and the gap top 204. The bottom face 107 and the plunger plate face 106 may be constructed to be smooth such to allow for a compressed slide spring to more easily slide on along the plunger plate face 106 and the bottom face 107. Once the slide spring is compressed against the gap bottom 203 and the gap top 204, the plunger 109 may be removed from the receiver 108. The gap bottom 203 and the gap top 204 are on opposite ends of the spring gap 104. The plunger assembly 103 having the plunger arms 201 which are the material outside of the spring gap 104.

The dimensions of the spring gap 104 are such that a slide spring may fit within when the slide spring is compressed. The dimensions are slightly larger than the diameter of the slide spring so there is not interference between the slide spring and the plunger arms 201 when the slide spring is pushed into the spring gap 104. The spring gap 104 is a cavity 110 in the plunger assembly 103 having dimensions that fits a compressed slide spring. The cavity 110 allows for a slide spring to be moved from between the plunger plate face 106 and the bottom face 107 to the cavity 110. The cavity 110 further allows for a slide spring to be moved from the cavity 110 in an opposite direction as to how the slide spring was inserted when moved into the cavity from between the plunger plate face 106 and the bottom face 107.

FIG. 3 is a set of drawings showing the 2D perspective of an exemplary slide spring tool 101 body 102. The drawing shows three sides of the body 102 including the side, front, and top perspective. The body 102 is comprised of a receiver 108 and a block assembly 301.

The block assembly 301 is the material surrounding the receiver 108. The receiver 108 is the open area in which the plunger 109 may be slid. The receiver 108 is shaped such that the shape of the plunger 109 may pass or be slid through the receiver 108. The plunger 109 slides in the receiver 108. The receiver 108 is a hole in the body 102. Surrounding the receiver 108 is a set of body arms 303 (shown as 303a and 303b) and a set of body bases 302 (shown as 302a and 302b). The body bases 302 and the body arms 303 may come in any shape which is capable of providing the structural function of the body 102, the area needed for applying pressure on a slide spring by the bottom face 107 and allows for the plunger 109 to be slid in the receiver 108. The bottom face 107 is understood to be one face of either of the body bases 302 which is of requisite size to apply pressure on an end of a slide spring. The body 102 may be configured symmetrically or asymmetrically such that the faces may be selectively used by the rebuilder.

The dimensions of the receiver 108 are such that the plunger 109 may slide within. The dimensions are slightly larger than the dimensions of the plunger 109 so there is not interference between the block assembly 301 and the plunger 109.

The invention disclosed herein may be used for applications other than a slide spring which is used on an oil pump assembly in a General Motors transmission. Further, the invention disclosed may be configured to be used on springs which are smaller or larger than a conventional slide spring.

The plunger assembly 103 and body 102 may be constructed from a variety of materials including but not limited to metal, plastic, or other such materials.

### Explanation of Exemplary Language

While various inventive aspects, concepts and features of the general inventive concepts are described and illustrated herein in the context of various exemplary embodiments, these various aspects, concepts, and features may be used in many alternative embodiments, either individually or in various combinations and sub-combinations thereof.

Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A slide spring tool comprising:
a body, the body comprising a receiver, a block assembly, and a bottom face; the receiver is a hole in the body, the block assembly is a material surrounding the receiver, the body having the bottom face; and
a plunger assembly, the plunger assembly comprising a plunger, a spring gap, and a plunger plate, the plunger plate having a plunger plate face, the plunger plate face located opposite to the bottom face when the plunger is slid in the receiver, the receiver is shaped such that the plunger slides in the receiver, the spring gap is a cavity in the plunger assembly having dimensions that fit a compressed slide spring, the plunger assembly having plunger arms located outside of the spring gap.

2. The slide spring tool of claim 1, wherein a slide spring fits between the bottom face and the plunger plate face when the slide spring is not compressed.

3. The slide spring tool of claim 1, wherein the plunger assembly and the body are constructed from metal.

4. The slide spring tool of claim 1, wherein the plunger assembly and the body are constructed from plastic.

5. The slide spring tool of claim 1, wherein the plunger is fully removed from the receiver.

6. The slide spring tool of claim 1, further comprising a body arms and a body bases that surround said receiver wherein the dimensions of said receiver allow said plunger to slide within said receiver.

7. The slide spring tool of claim 6, wherein the body bases and body arms provide structural function for said body.

8. The slide spring tool of claim 1, wherein the plunger assembly and the body are constructed from plastic.

9. The slide spring tool of claim 1, wherein a plunger slide face is constructed to be smooth.

10. The slide spring tool of claim 1, wherein the bottom face is constructed to be smooth.

11. The slide spring tool of claim 1, wherein the spring gap allows a compressed slide spring to axially center between a gap bottom and a gap top, gap bottom and the gap top are on opposite ends of the spring gap.

12. The slide spring tool of claim 1, wherein the spring gap allows for a slide spring to fit within when compressed wherein the spring gap allows for no interference between the slide spring and said plunger arms when the slide spring is pushed into said spring gap.
